(19) United States
(12) Patent Application Publication
(10) Pub. No.: US 2015/0278774 A1
(43) Pub. Date: Oct. 1, 2015

(54) TECHNIQUES FOR HASH INDEXING

(71) Applicant: Bank of America Corporation, Charlotte, NC (US)

(72) Inventors: Dennis H. Barrows, Charlotte, NC (US); Murali Jayakumar, Charlotte, NC (US); Narayanan Srinivisan, Charlotte, NC (US); Lee A. Thompson, Charlotte, NC (US)

(73) Assignee: Bank of America Corporation, Charlotte, NC (US)

(21) Appl. No.: 14/230,889

(22) Filed: Mar. 31, 2014

(51) Int. Cl. G06Q 20/02; G06Q 20/10; G06F 17/30

(52) U.S. Cl. CPC G06Q 20/027; G06F 17/3033; G06F 17/30864; G06Q 20/10

(57) ABSTRACT

Apparatus for hash indexing is provided. The apparatus may be used to process a database operation request. The request may relate to a database element. The requested database element may correspond to an alphanumeric ABA routing identifier and a bank account identifier. The method may include receiving the operation request, performing a hashing operation on each of the alphanumeric ABA routing identifier and the bank account identifier to form a key for use with the operation request and performing the operation request using the key to obtain an output string. While rendering a result of the operation request for display, the method may further include comparing or filtering the output string to determine whether the output string correctly corresponds to the ABA routing identifier and a bank account identifier. The method may also include, following the comparing or filtering, displaying the output string.

### FIELD OF TECHNOLOGY

The disclosure relates to techniques for use of data in hash-indexing.

### BACKGROUND OF THE DISCLOSURE

Many database applications require a limited amount of dictionary operations such as insert, search and delete. A hash table may be used for implementing such operations, or other suitable operations. A hash table is defined by an array index that is calculated based on key values, as opposed to an array index that uses the keys themselves. The array index is formed from slots that may include one or more keys.

In circumstances where the number of keys actually stored is small relative to the total number of possible keys, hash tables become an effective alternative to directly addressing an array.

One problem associated with hash-indexing is that it can occur that more than one key can map to the same slot in an array index. Such a circumstance is called a “collision.”

There are known techniques for resolving collisions. Such techniques may include, for example, chaining. In chaining, all the elements that collide in the same slot are stored in a linked list. All the member of the linked list may be accessed via the slot. However, to obtain the member of the linked list that satisfies the dictionary operation, it may be necessary to search through the members of the linked list for the desired element.

Such a search through the members of the linked list, in the case of hashing with chaining, or, with regard to another collision mitigation technique, may preferably be time-consuming and reduce the efficiency obtained by the hashing itself.

In some databases, such as the Netezza database manufactured by IBM of Armonk, N.Y., there may be a need to retrieve very large amounts of data at a high concurrency rate from the Netezza database to support existing requirements. Such existing requirements may include a return requirement of one second on information reporting.

However, conventional hashing with chaining and/or other conventional collision mitigation techniques do not necessarily provide adequate support for meeting the existing requirements.

Accordingly, it would be desirable, therefore, to provide techniques for improving database use and accessibility.

It would also be desirable to perform hash indexing even where components of a key are so large, or otherwise sub-optimally compatible with a database, as to make hash indexing cumbersome if not completely unworkable.

### SUMMARY OF THE DISCLOSURE

Systems and methods for processing a database operation request, the request relating to a database element, are provided. The requested database element may include an alphanumeric ABA routing identifier and a bank account identifier. The system may include a receiver for receiving the operation request. The system may also include a processor for performing a hashing operation on the alphanumeric ABA routing identifier and the bank account identifier to form a key for use with the operation request. The processor may be further configured to use the key to obtain an output string. While rendering for display the output string retrieved by the operation request, or during some other suitable time period, the processor may be further configured to compare the output string to the alphanumeric ABA routing identifier and the bank account identifier to determine whether the output string is accurate. Following the comparing, the processor may be further configured to render the output string for completion of the operation request.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows another illustrative apparatus in accordance with the principles of the invention;

FIG. 3 shows a schematic diagram of a generic hashing algorithm for use with the principles of the invention;

FIG. 4 shows illustrative steps of a process in accordance with the principles of the invention; and

FIG. 5 shows illustrative steps of another process in accordance with the principles of the invention.

### DETAILED DESCRIPTION OF THE DISCLOSURE

Certain embodiments of the invention are directed to systems and apparatus for working with the Netezza databases and/or with other databases that share the same or similar characteristics.

Netezza is not a traditional database that utilizes indexes to support the retrieval of data. It is a database warehouse appliance that uses extensive parallel processing to distribute requests to multiple Snippet Processing Units (“SPUs”) that break up the requests into smaller parts with each request retrieving its associated data. In order for this to be responsive and also reduce the amount of disk input/output (“I/O”), data organization and storage is very important.

To help facilitate this data retrieval, data is organized on disk(s) using a predetermined set of criteria. Another very important part of data retrieval relates to database zone maps that work with the data. Zone maps may be understood for the purpose of this application as vectors that identify the exact location of specific data contents on disk.

Data storage plans according to the embodiments may include plans for retrieving and updating data. One important criteria, according to the embodiments, is that all the data includes ABA routing number (“ABA number”) and/or bank account numbers, as these numbers are preferably always present in every request according to the embodiments. Both of these fields allow for alphanumeric values. When certain databases store alpha data, these databases do not necessarily store this information with the same efficiency as they store numeric or specifically-integer values. Accordingly, some embodiments may convert alpha data into numeric data to increase the efficiency of database operations, while maintaining the integrity of the database.

Since ABA and account numbers form the main components of certain types of searches, embodiments may, in addition to other steps, preferably convert all characters, alpha values and other values, in the ABA and account numbers, into a hashed, numeric equivalent. Such a numeric equivalent preferably ensures uniqueness and can be stored as integers in a database. Such a conversion preferably supports at least two of the following advantages:

1) The conversion preferably orders the data on disk using a hashed ABA/Account value, so that data for a single account was substantially co-located on disk.

2) The conversion preferably utilizes the base search capabilities of searching on integers using zone maps and preferably avoids the extra steps and/or additional time associated with searching on alpha characters.

The following is one exemplary algorithm that implements the alpha conversion in ways that may be used according to the invention. Such an algorithm, or other suitable algorithm, may combine the various contents of the ABA/Account data to create nearly 100% uniqueness.

In the following example, an exemplary prime value of 31 is used. Other suitable values also may be used without departing from the scope of the invention.

The ABA and account number are concatenated together with a dash (“-”) in the middle.

For each character in the resulting string, the prime value is multiplied against the previous running total. Then, the algorithm adds in the resulting Unicode value of the character currently being processed.

For example, if this is the first pass and the ABA/Account is “ABA”-“123A”, the algorithm would start with processing the “A” value first. The Unicode equivalent of “A” is 65. Since no previous values have been processed the initial total is now 65.

As each subsequent alpha character is processed, the Unicode value of that character is extracted and added to (the prime number multiplied by the previous result.)

For example processing the next letter in the previous example “B” would result in 66 (the Unicode of B) added to (the prime (31) times the previous result (65).) This preferably obtains a new value of 2081. 65*31+66.

This will continue until each value of the initial conversion is completed.

Then the algorithm preferably performs the same process on the account number by itself.

Then each half of the equation—i.e., the ABA and the account number identifier and the account number identifier by itself—may be converted from to a numeric string and the two halves are concatenated together.

In one exemplary case, the term ABA of “ABA” is taken with an account number of “123”.

The first hashing of “ABA-123” would equate to a value of 1963185596.

The 2^{nd} part of “123” would obtain a value of 1509455.

Then the 1^{st} result may be appended to the 2^{nd} result, thereby converting the final result to the ending hash value: 19631855961509455.

Exemplary code for the process of generating the hash value is attached below for reference.

In certain embodiments, for every transaction record in an entity database, this new hash value may be stored along with the original ABA and account.

Every future request to the database preferably includes the stored hash value as part of the request. The data in the database may be distributed based on this hash value. Such databases may preferably be utilizing built-in zone maps for all integers. Such embodiments may preferably reduce disk I/O, thereby resulting in faster response and higher concurrent request threshold.

At least because the hash values are relatively extensive, tests indicate that the hash value is always unique for all data entered. Nevertheless, to reduce further the chances of incorrect data retrieval regarding ABA/Account combinations that could have the same hash value, certain embodiments may implement a filtering process while retrieving the data.

As each record is retrieved from the database, it is preferably compared—i.e., filtered—with the ABA and account identifier that originally formed part of the request. If the filtering process determines that the retrieved record does not match the requested record, then the retrieved record is discarded and the user never sees it. This filtering algorithm may be implemented during runtime in the IR/H2H application. In one embodiment of the filtering, the following steps may be implemented—when a request is initially created, a hash table of the ABA and accounts being requested may also be created. Each is stored in an object called AccountKey. This AccountKey object may contain the ABA and account identifiers. The ABA and account identifiers may be used as the key for use with the hash table. As data is retrieved from a data warehouse appliance such as Netezza, the following three pieces of information—the ABA, the account identifier, and the hashcode—may be used to ensure that the ABA and account identifier retrieved from the data warehouse appliance match the originally-requested key stored in the AccountKey object.

In order to process the resulting rows of data, the retrieved rows should preferably be mapped to Java objects, or some other suitable objects. While those records are being mapped, the checking of the retrieved data against the information stored in the AccountKey may occur. If any one of the ABA, account identifier or the hashcode does not match, then the row associated with the failure to match is discarded from further processing and a warning message is logged in application logs.

A monitoring system may be set up that monitors for this message and if a warning message is generated, the monitoring system may send out an alert to administrators or other suitable parties. If this happened, an embodiment of the hashing algorithm may preferably review the cause of the occurrence and adjust accordingly. In the event of a duplicate hash code resulting in retrieval of an unintended record, the unintended record is disposed of prior to any processing of the unintentionally retrieved record. This preferably ensures that even if the smallest mathematical situation occurs, the embodiments may preferably discard any incorrectly retrieved results.

```
        String firstHalfString;
        String firstHalfHashString;
        String secondHalfString;
        String secondHalfHashString;
        int secondHalfHash;
        firstHalfString = aBASWIFT + “−” + accountNumber;
        secondHalfString = accountNumber;
        int h = 0;
        int off = 0;
        char val[ ] = firstHalfString.toCharArray( );
        int len = firstHalfString.length( );
        for (int i = 0; i < len; i++)
        {
            h = 31*h + val[off++];
        }
        firstHalfHashString = Integer.toString(h);
        h = 0;
        off = 0;
        val= secondHalfString.toCharArray( );
        len = secondHalfString.length( );
        for (int i = 0; i < len; i++)
        {
              h = 31*h + val[off++];
        }
        secondHalfHash = h;
        if (secondHalfHash < 0) {
              secondHalfHash = secondHalfHash * −1;
        }
        secondHalfHashString = Integer.toString(secondHalfHash);
        if (secondHalfHashString.length( ) > 9) {
```

| | |
|---|---|
| secondHalfHashString | = |

secondHalfHashString. substring(0,9);
}

| | |
|---|---|
| long result=Long.parseLong(firstHalfHashString | + |

secondHalfHashString);
return result;

Certain embodiments may include a method for obtaining a requested database element. The requested database element may include an alphanumeric ABA routing identifier and a bank account identifier. The bank account identifier may or may not include alphabetical characters.

The method may include receiving an alphanumeric ABA routing identifier. The method may further include performing a conversion algorithm on the characters associated with the ABA routing identifier. The converted characters associated with the ABA routing identifier may form a numeric string.

The method may further include receiving a bank account identifier. The bank account identifier may be alphanumeric or just numeric. The method may include performing a conversion algorithm on the characters associated the alphanumeric bank account identifier, wherein the converted characters associated with the alphanumeric bank account identifier following the converting form a numeric string.

The method may further include concatenating the numeric string derived from the ABA routing identifier with the numeric string derived from the alphanumeric bank account identifier to form a concatenated numeric string. The method may also include concatenating the concatenated numeric string with the numeric string associated with the alphanumeric bank account identifier to form a second concatenated numeric string. In some embodiments, the second concatenated numeric string may be made available for use with database operations.

The method may also include obtaining an output string via a database search. The database search may be based on the second concatenated numeric string.

The method may also include confirming that the output string corresponds to the requested database element.

The method may also include, substantially simultaneously to rendering the output string for display to a database user, confirming that the output string corresponds to the requested database element.

In certain embodiments, the database operations may include an operation selected from a group consisting of insert, search and delete.

In some embodiments, a maximum of 32 bytes may be made available for the second concatenated numeric string.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

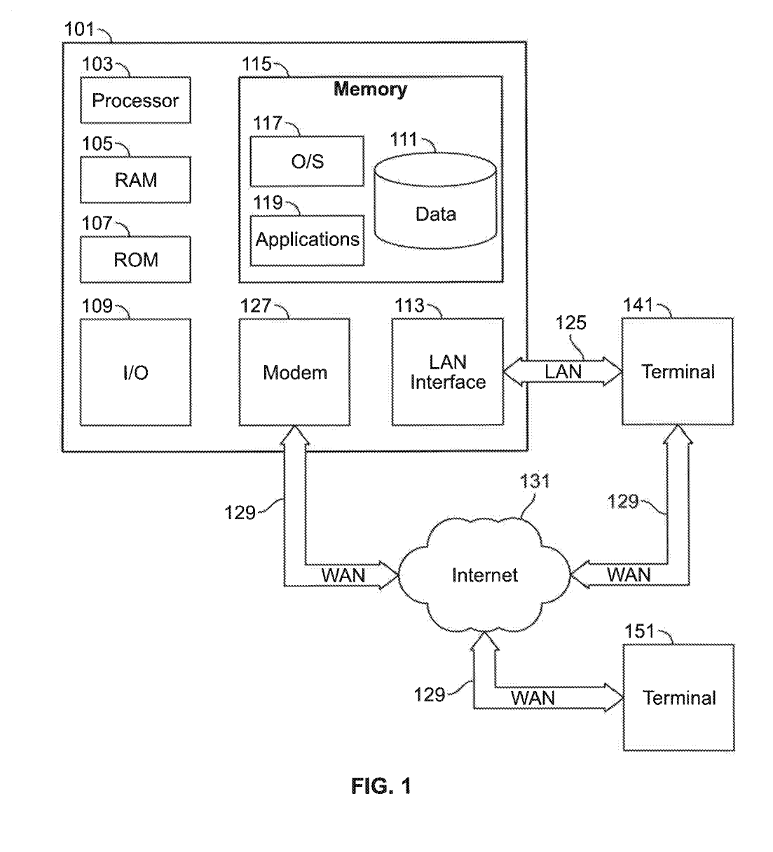

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into one or more of the database(s) described herein, hashing algorithms, collision mitigation algorithms, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

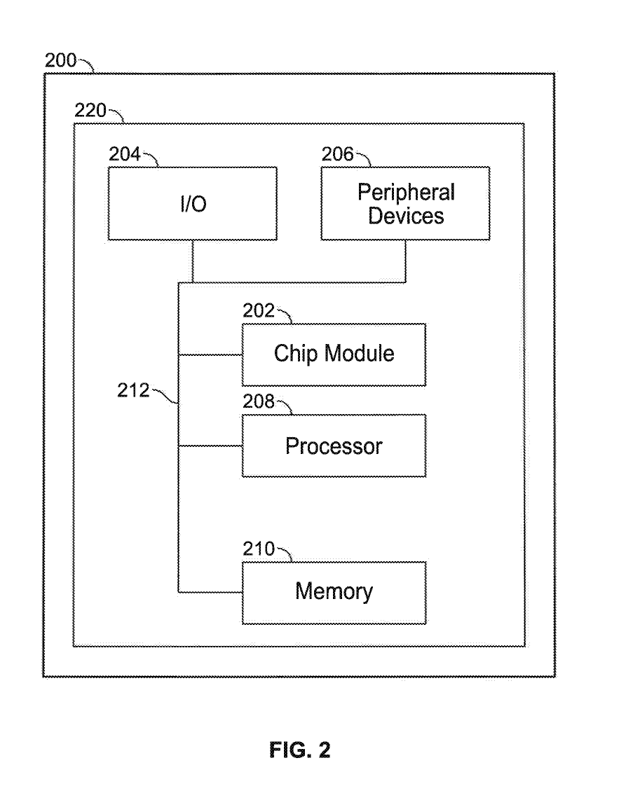

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data, quantify indices; and machine-readable memory 210.

Machine-readable memory 210 may be configured to store in machine-readable data structures: data lineage information; data lineage, technical data elements; data elements; business elements; identifiers; associations; relationships; and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

It will be appreciated that software components including programs and data may, if desired, be implemented in ROM (read only memory) form, including CD-ROMs, EPROMs and EEPROMs, or may be stored in any other suitable computer-readable medium such as but not limited to discs of various kinds, cards of various kinds and RAMs. Components described herein as software may, alternatively and/or additionally, be implemented wholly or partly in hardware, if desired, using conventional techniques.

Various signals representing information described herein may be transferred between a source and a destination in the form of electromagnetic waves traveling through signal-conducting encoded media such as metal wires, optical fibers, and/or wireless transmission encoded media (e.g., air and/or space).

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

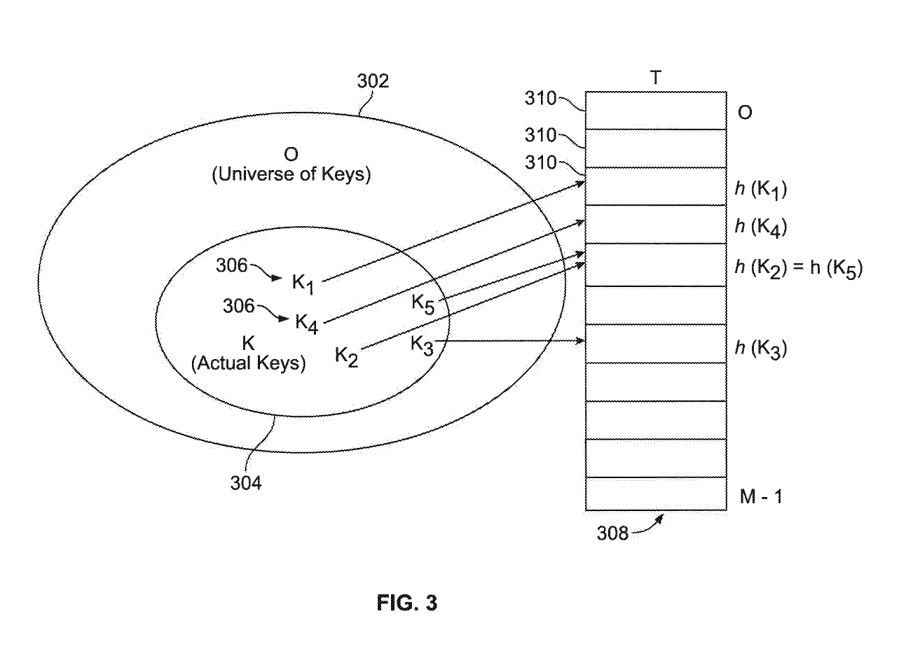

FIG. 3 shows a schematic diagram of a generic hashing algorithm for use with the principles of the invention. Universe of keys (“O”) is represented at 302. In the context of a hashing algorithm, actual keys 304 represent a far smaller number of keys than all the possible keys available in an O-size universe of keys.

In a typical hashing operation, a hash function is used to compute a slot 308 based on one of actual keys 306. In FIG. 3, function h maps keys 306 into slots 310. Collisions may occur when more than one of actual keys 304 maps to a single slot 310. When collisions occur, the results may cause an incorrect retrieval of the key as the system may insert, search for or delete an incorrect key. In such instances, known collision mitigation techniques, such as chaining, may be used to mitigate the effects of collisions on hashing functions by adding on an additional layer of key identification when necessitated by a collision.

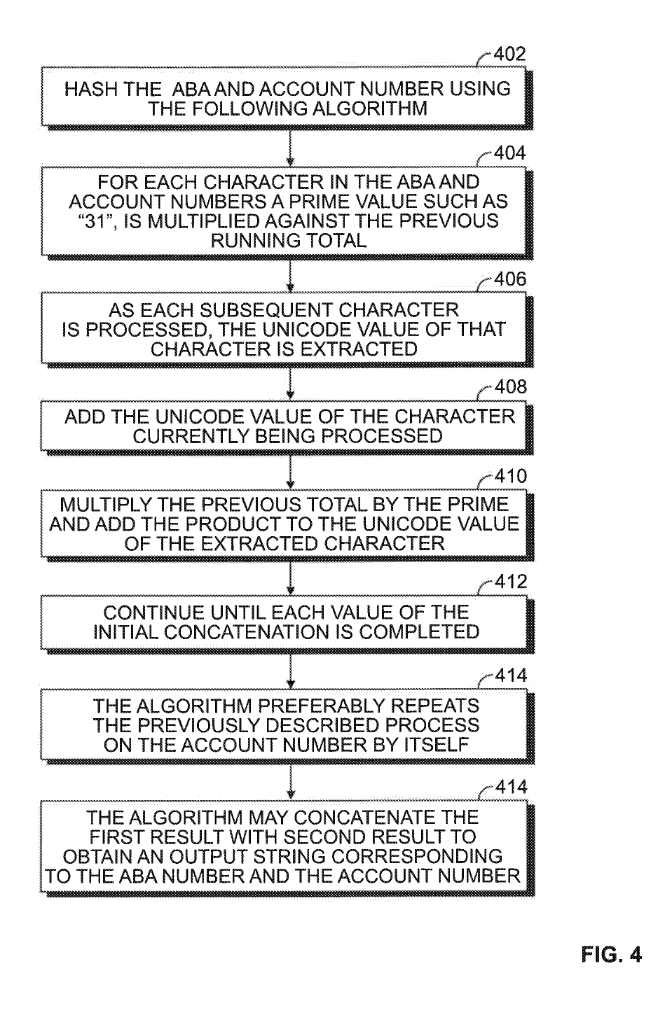

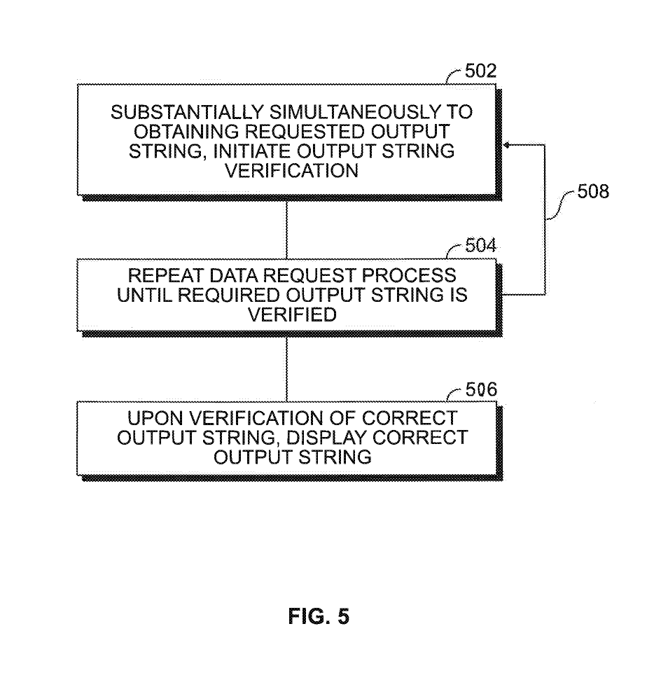

FIGS. 4 and 5 show algorithms using hashing functions for use with embodiments. Such embodiments may be preferably implemented with data warehouse appliances that use extensive massively parallel processing to distribute requests to multiple SPUs, as described in more detail above.

FIG. 4 shows illustrative steps of a process in accordance with the principles of the invention. The steps shown in FIG. 4 preferably reflect a hashing algorithm according to some embodiments.

The hashing algorithm is based on receipt and/or possession of an ABA number(s) and/or a preferably corresponding bank account number(s). Each (or a single one) of the ABA number and/or the bank account numbers may typically be formed from a combination of alphabetical and numeric characters.

FIG. 4 shows step 402 which corresponds to hashing the ABA and the account number according to an exemplary algorithm.

Step 404 shows that, for each character in the ABA and account numbers, an exemplary prime value, such as “31”, is multiplied against the previous running total. Step 406 show that, as each subsequent character is processed, the Unicode value of that character is extracted.

Step 408 shows adding the Unicode value of the character currently being processed. Step 410 shows multiplying the previous total by the prime and adding the product to the Unicode value of the extracted character.

Step 412 shows continuing the process until each character of the ABA and account number have been processed. At this point, the initial concatenation is completed.

Step 414 shows that the algorithm preferably repeats the same or a similar process on the account number alone. Step 416 shows that the algorithm may concatenate the first result with the second result to obtain an output string that uniquely corresponds to the ABA number and account number.

FIG. 5 shows illustrative steps of another process in accordance with the principles of the invention. Step 502 shows, in one embodiment, substantially simultaneously to obtaining the requested output string and/or substantially simultaneously to rendering the output string for display, initiating output string verification. It should be noted that output string verification may also occur after obtaining the requested output string and may include comparing a stored value for the output string to the retrieved value of the output string to implement the verification. Step 504 shows repeating the output string verification, as indicated schematically by path 508, until a requested output string is verified.

Step 506 shows, upon verification of correct output string, displaying correct output string on, for example, a user workstation for viewing by a user.

Thus, methods and apparatus for processing techniques for hash indexing have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. An article of manufacture comprising a non-transitory computer usable medium having computer readable program code embodied therein, the code when executed by one or more processors configuring a computer to execute a method for obtaining a requested database element, wherein the requested database element includes an alphanumeric ABA routing identifier and a bank account identifier, the method comprising:
receiving the alphanumeric ABA routing identifier;
performing a conversion algorithm on the characters associated with the ABA routing identifier, wherein the converted characters associated with the ABA routing identifier following the converting form a numeric string;
receiving the bank account identifier;
if any alphabetical characters are associated with the bank account identifier, performing a conversion algorithm on all the characters associated the bank account identifier, wherein the converted characters associated with the bank account identifier following the converting form a numeric string;
concatenating the numeric string derived from the ABA routing identifier with the numeric string derived from the bank account identifier to form a concatenated numeric string;
concatenating the concatenated numeric string with the numeric string associated with the bank account identifier to form a second concatenated numeric string wherein the second concatenated numeric string is available for use with obtaining an output string via a database search, said database search being based on the second concatenated numeric string; and
confirming that an output string corresponds to the requested database element.

2. The article of manufacture of claim 1, wherein the confirming further comprises creating an object which stores the ABA routing identifier, the bank account identifier and the second concatenated numeric string as a single record comprising multiple rows, wherein each row of the multiple rows corresponds to one of the ABA routing identifier, the bank account identifier and the second concatenated numeric string.

3. The article of manufacture of claim 2, wherein the method further comprises, in response to failure to confirm a row associated with one of the ABA routing identifier, the bank account identifier and the second concatenated numeric string, discarding the unconfirmed row.

4. The article of manufacture of claim 1, wherein the method further comprises, substantially simultaneously to rendering the output string for display to a database user, confirming that the output string corresponds to the requested database element.

5. The article of manufacture of claim 1, wherein the database operations comprise an operation selected from a group consisting of insert, search and delete.

6. The article of manufacture of claim 1, wherein a maximum of 32 bytes is available for the second concatenated numeric string.

7. The article of manufacture of claim 1, wherein the second concatenated numeric string comprises a maximum of 32 characters.

8. The article of manufacture of claim 1, wherein the confirming that an output string corresponding to the requested database element comprises comparing the concatenated numeric string associated with the retrieved database element to a stored value of the concatenated numeric string.

9. An article of manufacture comprising a non-transitory computer usable medium having computer readable program code embodied therein, the code when executed by one or more processors configuring a computer to execute a method for processing a database operation request, the request relating to a database element, wherein the requested database element corresponds to an alphanumeric ABA routing identifier and a bank account identifier, the method comprising:
receiving the operation request;
performing a hashing operation on each of the alphanumeric ABA routing identifier and the bank account identifier to form a key for use with the operation request;
performing the operation request using the key to obtain an output string;
while rendering a result of the operation request for display, comparing a key retrieved with the output string to the key used to retrieve the output string to determine whether the output string is accurate; and
following the comparing, displaying the output string.

10. The article of manufacture of claim 9, wherein the hashing operation further comprises receiving a first component part of a key, the first component part of the key corresponding to the alphanumeric ABA routing identifier;
converting alphabetical characters associated with the ABA routing identifier to numeric characters, wherein the remaining characters associated with the ABA routing identifier and the converted numeric characters are used to form a numeric string;
converting the bank account identifier into a second numeric string; and
combining the numeric string and the second numeric string to form a first hashed value.

11. The article of manufacture of claim 9, wherein the database operations comprise an operation selected from a group consisting of insert, search and delete.

12. The article of manufacture of claim 9, wherein the method further comprises using a chaining algorithm to mitigate the impact of collisions on the hashing operation.

13. The article of manufacture of claim 9, wherein the key comprises a 32-character numeric string.

14. The article of manufacture of claim 9, further comprising comparing the output string to the alphanumeric ABA routing identifier and the bank account identifier to determine whether the output string is accurate.

15. A computer system for processing a database operation request, the request relating to a database element, wherein the requested database element includes an alphanumeric ABA routing identifier and a bank account identifier, the system comprising:
a receiver for receiving the operation request;
a processor for performing a hashing operation on each of the alphanumeric ABA routing identifier and the bank account identifier to form a key for use with the operation request;
the processor further configured to use the key to obtain an output string;
while rendering, for display, output string retrieved by the operation request, the processor further configured for comparing the output string to the key to determine whether the output string is accurate; and
following the comparing, the processor further configured to render the output string for completion of the operation request.

16. The computer system of claim 15, wherein:
the processor is further configured to convert alphabetical characters associated with the ABA routing identifier into numbers;
following the conversion, the characters associated with the ABA routing identifier form a numeric string;
the processor is further configured to convert alphabetical characters, if any exist, associated with the bank account identifier into numbers;
the processor is further configured to hash the numeric string associated with the ABA routing identifier and the numeric string associated with the bank account identifier to form a first hashed value.

17. The computer system of claim 15, wherein the database operations comprise an operation selected from a group consisting of insert, search and delete.

18. The computer system of claim 15, wherein the processor is further configured to mitigate the impact of collisions on the hashing operation by filtering the output string.

19. The computer system of claim 15, wherein the key comprises a 32-character numeric string.
